(19) United States
(12) Patent Application Publication
(10) Pub. No.: US 2012/0302267 A1
(43) Pub. Date: Nov. 29, 2012

(54) APPARATUS AND METHOD FOR USE IN A FEMTO CELL

(75) Inventors: Russell John Haines, Bristol (GB); Timothy Adrian Lewis, Bristol (GB)

(73) Assignee: KABUSHIKI KAISHA TOSHIBA, Tokyo (JP)

(21) Appl. No.: 13/503,522

(22) PCT Filed: Oct. 21, 2009
(86) PCT No.: PCT/GB2009/002506

§ 371 Date: Aug. 3, 2012

(51) Int. Cl. H04W 4/14

(52) U.S. Cl. 455/466

(57) ABSTRACT

A HNB or Femto-Cell base-station arranged to locally re-route text based messages originating form locally residing user equipment or appliances if the destination device is also residing within the area covered by the Femto-Cell. The Femto-Cell base station may be arranged to exert a degree of autonomous control of local appliances based on rules and determine desired recipients of locally originating messages.

### FIELD OF THE INVENTION

The present invention relates to the routing of messages by a Femto Cell base station. The present invention in particular relates to the local re-routing of text based messages by a Femto Cell base station, for example in a home.

### BACKGROUND

Short Message Service (SMS) messages are a well known and a popular means sending of interpersonal messages. SMS could also find use in transmitting messages from home appliances to a user and vice versa, so that, for example the status of an appliance can be notified to a user while he or she is not in the vicinity and/or the user can send operating commands to the appliance from a remote location. Messages of this nature may, for example, include alert messages that an appliance is not operating as intended. Examples of such messages include messages indicating that an appliance, such as a freezer, has lost power or messages indicating that an appliance has finished an operation, such as an alert that a washing machine has completed a wash cycle. It will be appreciated from the above that the short messaging service is not only popular but also provides considerable scope for remote operation of buildings and appliances. It will be appreciated that due to its popularity and utility the volume of messaging traffic based on messages of the above described nature can be considerable and is set to increase even further.

The standard network architecture for SMS revolves around the Short Message Service Message Switching Centre, often referred to as SMSMSC but sometimes also as SMSC. SMSMSCs are placed inside public land mobile networks (PLMNs). Each PLMN has one or more SMSMSC, which provides store-and-forward functionality. Messages are stored in the SMSMSCs until the user equipment specified as the destination of the message becomes available to receive it. For this purpose SMSMSCs cooperate with one or more voice call switching centres and/or Home and Visitor Location Registers which track a current location of user equipment. The SMSMSC can store and deliver messages based on information from these switching centres and registers. WO 2009/046159, which is incorporated herein by this reference in its entirety, provides and example of a network incorporating an SMSMSC. US 2009/0067417 and US 2009/0052395, which are incorporated herein by this reference in their entireties, disclose further networks where SMS traffic is routed via the network backhaul. The formats of mobile terminated SMS message frames transmitted over air interface, referred to as SMS-MT, and mobile originated SMS message frames transmitted over air interface, referred to as SMS-MO, are available in the GSM/3GPP standards, which are incorporated herein by this reference in their entirety, as well as several text books on the subject, such as for example Redl, Weber & Oliphant, “GSM and Personal Communications Handbook”, Artech House, 1998, pp. 216-218, which is incorporated herein by this reference in its entirety.

### SUMMARY OF THE INVENTION

For the purposes of this description, a Femto-Cell base-station (or home NodeB/home eNodeB in the 3GPP parlance, hereinafter referred to as ‘HNB’), is considered to be a small-scale user-deployed base-station supporting a restricted (relative to a full-size cellular base-station) number of connected terminals, offering coverage in a small volume approximately the size of a single home. The Femto-Cell base station may connect via a broadband connection, such as a home broadband connection, to a network operator's infrastructure over the Internet. References to Femto-Cell base stations are intended to include the above references HNBs as well as limited size cells based on Wireless Metropolitan Area Network technologies such as WiMAX.

According to an aspect of the present invention there is provided a Femto-Cell base station comprising a switching means arranged to route a text based message received from a transmitter that is in direct communicative contact with the Femto-Cell base station and destined for a recipient that is also in direct communicative contact with the Femto-Cell base station for direct transmission to the recipient. Put in other words the Femto-Cell base station re-routes messages that have originated locally, that is in the Femto-Cell area covered by the Femto-Cell base station, and that are directed towards a destination device that is also currently in the area covered by the Femto-Cell created by the Femto-Cell base station, so that such messages are transmitted to the intended receiver without having to be sent over the backhaul (typically an Internet connection) or over a macro cell or similar deployment belonging to a public land mobile network (PLMN). An increase in the amount of text based messages within the area covered by the Femto-Cell base station thus does not bring about an equivalent increase in the amount of backhaul data traffic. When compared to the function of known Femto-Cell base stations, the Femto-Cell base station of the present invention may be considered as intercepting locally originating messages on their way to the backhaul and, instead of simply relaying the message to the backhaul, re-routing them for local re-transmission if the destination device is located in the area covered by the Femto-Cell base station.

Femto-Cell base-stations are known in the art as means for providing wireless access to telecommunication networks and have been created to further reduce the size of the cells through which user equipment can access the network. It has long been realised that the transmission bandwidth of a network is severely limited by the range of its access points (base-stations), that is by the size of its cells. It has in particular been appreciated that a given cell can only grant access to a network for a limited number of devices. Larger cells are likely to comprise a correspondingly large number of devices attempting to access a network. The likelihood of interference between access attempts of different devices increases with the number of devices trying to gain access to a network via the same access point. With a finite number of resources (radio channels) there is a maximum number of devices that can be granted access simultaneously. The size of the cell may therefore become a limiting factor for network access. To increase capacity the coverage area can be further subdivided into smaller cells, each covered by a lower-power access point, with the potential for frequency reuse in non-adjacent cells. In light of this there has been a trend to reduce the size of a network cell and the inception of Femto-Cells is part of this trend. Femto-Cell base stations have in particular been designed to provide a highly localised access point to mobile networks and the coverage provide by each Femto-Cell may have a radius as small as 10 m. As a consequence of the small size of Femto-Cells a correspondingly small number of users are likely to be concurrently present within the area covered by the Femto-Cell base station. Femto-Cell base stations are consequently unlikely to ‘see’ a sufficient number of user devices for a routing function within the Femto-Cell base station to become useful and efficient.e Known Femto-Cell base stations thus do not comprise such routing functionality. Instead known Femto-Cell base stations simply relay messages received wirelessly from a device present within the Femto-Cell to the public land mobile network and vice versa without any decision on where to send the message being made in the Femto-Cell base station. Messages are then sent to, further stored in and forwarded by/from the SMSMSC, as discussed above. An example of a Femto-Cell arrangement is disclosed in EP 0 268 375, the entirety of which is incorporated herein by this reference. Further examples can be found at http://3ginthehome.wordpress.com/page/2/ and in a paper published by C.-S. Hwang, T.-S. Wey and Y.-H. Lo entitled “An integration platform for developing digital life applications” published in Parallel and Distributed Systems, 2007 International Conference on, Volume 2, pp 1-2. The entireties of both of these documents are incorporated herein by this reference.

The inventors have realised that the likelihood that a destination device is within the Femto-Cell is not the same for all message types. It has in particular been realised that for messages sent from a user to an associated appliance and vice versa it is considerably more likely that the intended recipient is located in the same Femto-Cell as the device from which the message has originated. Such messages are text based messages and messages of this type will therefore benefit more from a local re-routing functionality than other/non-text based messages. It is this local re-routing functionality that the present invention adds to Femto-Cell base stations. This functionality reduces the volume of backhaul traffic created by text based messages and consequently increases the network bandwidth available for other types of communication. Text based messages between members of a group of people that routinely occupy the same building, such as a family, may also benefit from local re-routing if they use text based messages for communication.

Text based messages may include any form of messages that use text as a means of conveying information. The most prominent examples are Short Messaging Service messages (in which case the above discussed re-routing function provided by the Femto-Cell base stations may be considered to constitute a local SMS message switching centre provided within the Femto-Cell base stations) and emails. Multimedia Messaging Service (MMS) messages comprising text elements may also be considered text based communications. The format of SMS messages is standardised and is therefore inherently suitable for sending commands to an appliance, say a household appliance such as a freezer, a washing machine, a fire alarm, burglar alarms, etc., to name a few. Appliances arranged to be remote controlled using SMS messages are commercially available. An example of a system for controlling devices using SMS messages can be found in EP 1 045 355, the entirety of which is incorporated by this reference. This document, however, suggests controlling devices through messages received via a public land mobile network, thereby creating enhanced traffic on the public land mobile network. Other documents, such as US 2009/0088155 and WO 2009/046159, both of which are incorporated herein in their entireties by this reference, suggest that a device that could be controlled by SMS is the HNB itself. This is different from the present invention, as the present invention does not utilise text based messages as a means of delivering control information to a Femto-Cell base station. Instead the present invention aims to deliver the text based message to further devices that may be within the area covered by the Femto-Cell base station but that does not form part of the Femto-Cell base station.

The Femto-Cell base station may comprise a receiver arranged to receive text based message from an area covered by the Femto-Cell base station and a transmitter arranged to transmit messages to the covered area. The receivers and transmitters may be transmitters and receivers commonly found in Femto-Cell base stations, may operate wirelessly and they may serve the same function as the transmitters and receivers commonly found in Femto-Cell base stations, namely the local transmission and reception of any type of message supported by the Femto-Cell base stations. The Femto-Cell base station, however, differs from such known Femto-Cell base stations in that it re-transmits locally originating messages (that is messages having been received directly by the Femto-Cell base station, rather than via intermediary devices, such as devices that form part of the macrocell/backhaul/public land mobile network) to appliances or user equipment that is also located within the area covered by the Femto-Cell base station. The present invention therefore removes the need for routing of messages of this type through the Femto-Cell base station to the public land mobile network. The present Femto-Cell base station may nevertheless be connected to the public land mobile network in the normal fashion so that messages that are destined for user equipment that is currently outside of the area covered by the Femto-Cell base station can be relayed to the user equipment without delay and so that messages originating outside of the area covered by the Femto-Cell base station can be transmitted to user equipment and/or appliances present within the area covered by the Femto-Cell base station. The Femto-Cell base station may transmit re-routed text based messages using the same air interface that is used for the transmission/reception of messages that are routed via the public land mobile network.

The switching means may comprise means for determining a destination address from a message received at the Femto-Cell base station. As the format of mobile originating and mobile terminating SMS messages is standard and the format of email and MMS messages is well known it is possible to parse text based messages received at the Femto-Cell base station and to thereby extract the destination address of the message. This extraction is made straightforward as destination addresses are often in a clearly defined and delimited field.

The switching means may also comprise a means or detector arranged to determine whether a device having a destination address specified by a message received at the Femto-Cell base station is located within an area covered by the Femto-Cell base station. This detector may take the form of a physical means, such as a transceiver, for determining that user equipment and/or appliances are in direct communicative contact with the Femto-Cell base station. Based on the output of this detector or detection means the node may then determine whether the message is to be re-transmitted locally or directed onto the macrocell/backhaul. It can also be envisaged that for static devices such as bulky household appliances such detection is not necessary and that it can safely be assumed that these devices are permanently located within the area covered by the Femto-Cell base station. It may then only be necessary to register the appliance with the Femto-Cell base station once as a static appliance, for example after the installation of the appliance or of the Femto-Cell base station.

The detection means/detector may be or comprise a record/list of those devices that are in direct communicative contact with the Femto-Cell base station. The record may, for example, comprise the user equipments or appliances MSISDN number as an identifier of the user equipment or appliance. The determination whether or not a device identified by the extracted destination address is within the area covered by the Femto-Cell base station may then be made through an inspection/search of the record. If the destination address in question is not located in the record, then it may be concluded that the destination device is not currently located in the area covered by the Femto-Cell base station. The record/list may be arranged to be dynamically updated. The Femto-Cell base station may, for example, add identifiers of user equipment and/or appliances that have been identified as being in direct communicative contact with the Femto-Cell base station to the record. This may be done by noting the addresses of user equipment and appliances that have sent messages to the Femto-Cell base station via a direct communicative contact/link and add the addresses of such user equipment and appliances to the list of devices or appliances that are currently in direct communicative contact with the Femto-Cell base station. Equally, devices that have been detected as being within the area covered by the Femto-Cell base station through an active detection step may also be added to the record. The Femto-Cell base station may be arranged so that entries are deleted from the records if no messages have been received from the device for a predetermined period of time.

The Femto-Cell base station may further comprise a processor that is arranged to associate messages received from within the area covered by the Femto-Cell base station with one or more destination addresses according to predetermined rules. This enables the received message to be re-routed to a number of destination addresses. Such re-routing is useful, for example, for messages received from appliances. It may, for example, be important that an alarm message from a fire alarm be re-routed to all user equipment currently located within the area covered by the Femto-Cell base station to alert as many individuals currently within the area covered by the Femto-Cell base station of potential danger. Other messages that may be desired to be transmitted to more then a single user equipment may be messages relating to the need for immediate action. It can, for example, be envisaged that a message from a freezer that it is suffering from mains power loss should be re-routed to a number of people, so that quick action can be taken. To ensure the swiftest possible response the recipients of such messages may be located within the area covered by the Femto-Cell base station. Messages that are to be transmitted to more than one recipient may be referred to a multicast messages, while message that art to be re-routed to a single recipient only may be referred to as unicast messages. Once the processor has associated a message with one or more destination addresses the messages can be transmitted to the devices having the chosen destination addresses via the direct communication link. It will of course be appreciated that the association of a message with one or more destination addresses is not limited to choosing destination addresses of appliances or user equipment known to be currently within the area covered by the Femto-Cell base station. It may be equally important that such messages are forwarded to user equipment that is not currently within the area covered by the Femto-Cell base station, for example an alert message from a burglar alarm sent to the Femto-Cell base station indicating that it has been activated. The processor may thus associate a message with one or more destination addresses of user equipment or appliances that are or are not directly within the area covered by the Femto-Cell base station.

From the above it will be appreciated that it is advantageous for some messages to be directed towards a recipient or plural recipients that are not specified by an application sending the message to the Femto-Cell base station. The recipient or recipients of such messages may instead be determined by the Femto-Cell base station, based on predetermined rules and/or on the nature and/or number of the pieces of user equipment that are present in the area covered by the Femto-Cell at the time of receipt of the message from the appliance. As already hinted at above, such rules may direct some messages, such as messages raising an alarm, such as a fire alarm or a burglar alarm, to pieces of user equipment known to be owned by persons considered most suitable for dealing with the alarm. These people may be identified known to the Femto-Cell base station in that the addresses of the pieces of user equipment owned by them are stored in the Femto-Cell base station. The rules may equally direct messages to different but predetermined groups of user equipment based on other criteria, for example the time of day, the presence or absence of certain pieces of user equipment within the area covered by the Femto-Cell base station, the nature of the alarm, etc. to name a few.

Moving the burden of choosing a destination address or destination addresses away from appliances that may send messages further has the advantages that a Femto-Cell base station capable of directing messages to user equipment or other appliances based on predetermined and stored rules (and without the need to receive an indication of the intended destination), can interact with and operate appliances that are technically not capable to send messages to particular recipients.

This has been recognised as being advantageous in its own right. According to another aspect of the present invention there is thus provided a Femto-Cell base station comprising a processor arranged to determine a message type of a message received at the Femto-Cell base station through direct communication and to forward the message to one or more destination addresses, the processor arranged to select the destination addresses based on the message type and on predetermined rules. Message types may include alert messages from appliances, which may be multicast, alert messages indicating movement of user equipment or appliances within the area covered by the Femto-Cell or indicating the completion of a process, such as a washing cycle of a washing machine or a drying cycle of a tumble dryer.

The Femto-Cell base station may further comprise means allowing inputting further rules and associations or altering existing ones of the predetermined rules or associations. Such means may be wireless.

The predetermined rules may further associate/logically link an appliance with one or more pieces of user equipment, such as with mobile telephones, laptops, PDAs etc. Equally, pieces of user equipment may be associated or logically linked with each other. It can, for example, be envisaged that a mobile telephone is logically linked to user equipment physically connected to a bunch of keys or a wallet and/or to a laptop or a PDA by the rules. The Femto-Cell base station may associate the user equipment/appliances with each other such that a detected change in the location of user equipment, such as the removal of the user equipment from the area covered by the Femto-Cell base station, causes the issue of an alert message from the Femto-Cell base station, if no corresponding change in location of the associated user equipment is detected. If, for example, the Femto-Cell base station detects that a user is about to leave the house, for example by detecting a change in the position of the mobile telephone, and if at the same time the Femto-Cell base station establishes that the locations of the keys, the laptop or the PDA are not changing in a manner that is consistent with their being carried by the user, then the Femto-Cell base station may send an alert message to the mobile telephone to this effect (thereby, in other words, reminding the user to take the items that they are about to leave without). The Femto-Cell base station may comprise a locator arranged to determine the location of a device within the area covered by the Femto-Cell base station.

The position of an appliance, such as a television set, may further be associated by the rules with another appliance, such as a burglar alarm. It can, for example, be envisaged that, if a change in the position of the appliance, in this example a television set, is detected after the burglar alarm has sent a message to the Femto-Cell base station that it has been activated, then an alert message to this effect may be sent to a further user equipment, such as to a mobile telephone. A change in position of the appliance may, for example constitute the removal of the appliance from the area covered by the Femto-Cell. Such removal can be detected by the Femto-Cell base station polling the devices expected to be in the area covered by the Femto-Cell. The absence of a response from a device in question can be taken to indicate that the devices has been removed from the area covered by the Femto-Cell, in particular in situations such as the one described above, where an activation message from a burglar alarm makes such a conclusion a reasonable one.

Put more generally, the Femto-Cell base station may be arranged to associate/logically link an appliance or user equipment with another appliance and/or user equipment through the rules and/or to the location of the other appliance and/or user equipment. The Femto-Cell base station may further be arranged to cause the sending of a message to user equipment or an appliance if it is determined that one or more conditions under a rule governing such an association have been fulfilled.

This has been recognised as being advantageous in its own right. According to another aspect of the present invention there is thus provided a Femto-Cell base station comprising rules linking two or more pieces of user equipment and/or appliances and means for monitoring the positions of the linked devices within the area covered by the Femto-Cell base station. The Femto-Cell base station further comprises means for determining if the positions (or relative positions) of the so linked devices are in accordance with a predetermined rule or with predetermined rules and to send a message to an appliance or user equipment if the positions of the devices are not in accordance with the rule or rules.

It has further been recognised that processing power associated with the rerouting of localised messages and in particular processing power associated with identifying message types and associating destination addresses with particular message types based on rules can also be used for providing rules based automatic control of home based appliances. Any spare processing power within the Femto-Cell base station may, for example, be used to control appliances in a manner that reduces the cost associated with their operation. Appliances requiring a large amount of operating power, for example, may be controlled by the processor of the Femto-Cell base station so that they are not operated during peak power times. The processor may instead determine a more optimal time, for example a time of the day where peak power demands are not normally encountered, and send a message to switch power intensive home appliances on so that they do not operate during peak power times, for example by only switching the home appliance on after peak power times. The processor may further be arranged to co-ordinate home appliances with each other, be that to reduce or limit the overall power consumed or to provide an otherwise efficient way of operating the appliances. Appliances may, for example be controlled so that an appliance that may be dependent from another appliance is controlled or activated as soon as the appliance from which it depends has created any necessary conditions for such control and/or activation. It can, for example, be envisaged that a washing machine and a tumble drier be selectively switched on so that they complete their washing/drying cycles respectively at the same time. The processor of the Femto-Cell base station may be arranged to achieve this by sending control messages and in particular activation messages to the individual appliances, having monitored the time of day and having determined, based on pre-determined rules, that activation of an appliance is appropriate.

This has been recognised as being advantageous in its own right. According to another aspect of the present invention there is provided a Femto-Cell base station arranged for controlling appliances, the Femto-Cell base station arranged to determine from pre-determined rules a need or desire to or a trigger event for change of an operating parameter of an appliance, to monitor a condition associated with the change of the operating parameter of the appliance and to send a text based message for changing the operating parameter to control the appliance when the condition is fulfilled.

The Femto-Cell base station may further comprise a traffic monitoring arrangement that is arranged to monitor the amount of locally rerouted text based message traffic, for example by counting the number of locally re-routed messages or by determining a bandwidth used for the local re-routing of these messages. The information acquired by the traffic monitor may be used as a basis for charging the proprietor of the Femto-Cell base station for the rerouting service.

According to another aspect of the present invention there is provided a Femto-Cell base station comprising a Short Messaging Service Message Switching Centre.

The present invention is not limited to the above described Femto-Cell base stations but also extends to apparatuses and systems that comprise the above described Femto-Cell base stations as well as appliances and user equipment that can enter into direct communicative contact with such Femto-Cell base stations. Such appliances and user equipment may comprise an appropriate transmitter, receiver or transceiver.

According to another aspect of the present invention there is provided a method of local message delivery within a Femto-Cell. The message comprises receiving at a Femto-Cell base station a text based message having a destination address, determining whether or not a device associated with the destination address is in direct communicative contact with the Femto-Cell base station and, if it is determined that the device is in direct communicative contact with the Femto-Cell base station, transmitting the message directly to the device. If it is determined that the destination address is not one of a device that is currently in direct communicative contact with the Femto-Cell base station, then the method may route the message to the macrocell/backhaul/public land mobile network.

The method may further identify a type of message received at the Femto-Cell base station and associate a predetermined type of message with a receiver or receivers according to predetermined rules. The method may further determine a location of a device within an area covered by the Femto-Cell base station and/or determine a change in the location of the device and send a message to the device or to a further device. Prior to the sending of the message it may be established whether a condition for the sending of the message is fulfilled.

According to another aspect of the present invention there is provided a method of routing a message in a Femto-Cell base station comprising receiving the message at the Femto-Cell base station via a direct communication link, determining a message type of the received message and forwarding the message to one or more destination addresses selected based on the message type and on pre-determined rules.

According to another aspect of the present invention there is provided a method of creating alert messages in a Femto-Cell base station comprising using a rule or rules to fink two or more pieces of user equipment and/or appliances that can establish a direct communication link with the Femto-Cell base station, monitoring the position of the linked pieces of user equipment and/or appliances within the area covered by the Femto-Cell base station, determining if the positions of the pieces of user equipment and/or appliances are in accordance with the rule or rules and sending a message to user equipment and/or an appliance if the positions are not within the rules.

According to another aspect of the present invention there is provided a method of controlling appliances with a Femto-Cell base station comprising obtaining an indication of a change for an operating parameter of an appliance, monitoring a condition associated with the change of the operating parameter of the appliance and sending a message from a Femto-Cell base station to the appliance to change the operating parameter of the appliance if the condition is fulfilled.

In addition, this solution is equally valid in the context of Unlicensed Mobile Access (UMA).

Embodiments of the present invention will in the following be described by way of example only.

### BRIEF DESCRIPTION OF THE DRAWINGS

FIG. 1 depicts the simplified architecture of a HNB/home-hub according to an embodiment of the present invention;

FIG. 2 illustrates a process of locally re-routing an appliance message;

FIG. 3 illustrates a process of routing a message to the macrocell;

FIG. 4 illustrates a process of locally re-routing a mobile originating message; and

FIG. 5 illustrates a process of routing a mobile originating message to the macrocell.

### DETAILED DESCRIPTION OF PREFERRED EMBODIMENTS

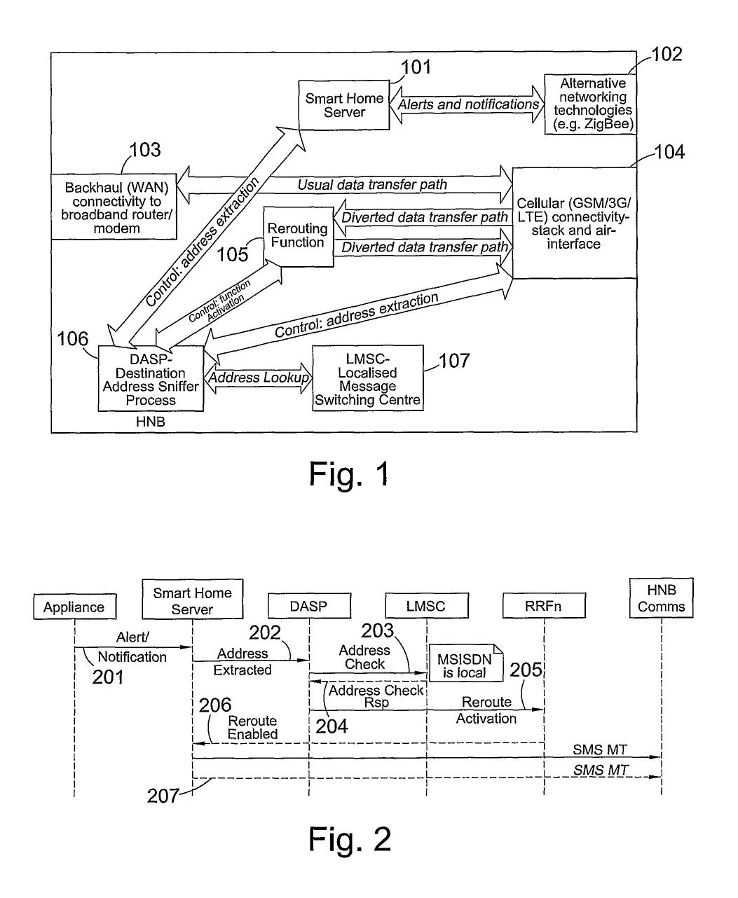

FIG. 1 shows a structural diagram of a Femto-Cell base station, in this case a home nodeB, according to an embodiment of the present invention. The HNB comprises a connection interface 103 that allows the HNB to be connected to the backhaul/WAN and a connection interface 104 to provide air-interface cellular connectivity. Known Femto-Cell base stations or hubs transmit incoming and outgoing messages between these two interfaces, so that the transmission of any message involves backhaul traffic. Additional connectivity 102 may optionally be provided through low-data-rate home networking technologies, such as ZigBee.

In addition to these input an output devices the Femto-Cell base station comprises a smart home server 101. The smart home server 101 may be a processor. One of the functions of the smart home server 1010 is to coordinate and control appliances subject to the direction of the Femto-Cell base station.

The smart home server 101 may also acts as the hub for other/all communication within a house, so that, for example, all information traffic relating to TVs and laptops is routed through it. The smart home server 101 may further fulfil the function of a home media server and hold media content involved in information traffic into and out of the area covered by the Femto-Cell.

The smart home server 101 may, for example, provide smart metering functionality, to allow the reduction of power consumption during peak times. The Femto-Cell base station may thus be operably connected to appliances with large energy consumption, such as tumble dryers, so that the home server 101 can switch such appliances off during peak times or place them on a reduced duty cycle, simply by sending an appropriate SMS message to any appliance concerned. This allows the operation of home appliances according to user specified operating patterns in a central manner through use of the Femto-Cell base station and the smart home server 101. The smart home server 101 may also automatically control some appliances. Such automatic control may take many forms. It is, for example, envisaged that the smart home server 101 may activate kitchen appliances, such as a coffee maker, at predetermined times of the day, week or month, to fit a user's requirement. Alternatively such user equipment may be activated automatically in reaction to a specific event. Home appliances that are normally used in the morning by a particular user, such as the coffee maker, may, for example, be activated by the smart home server 101 in reaction to the receipt of a signal from the alarm clock indicating the activation of the alarm clock.

Additionally or alternatively the smart home server 101 may control home appliances depending on a determined location of a user. The smart home sever may, for example switch on an oven as soon as, or a predetermined time after, the presence of a user within the area covered by the Femto-Cell is detected. Such detection may be facilitated by detecting the presence of mobile user equipment, such as a mobile telephone or a PDA, that is known to be carried by the user.

In another embodiment the smart home server 101 may not control some of the home appliances with which it is in communicative contact. For some appliances the smart home server 101 may instead simply enable the redirecting of messages from the appliance to an appropriate person or to an appropriate group of people. This is useful, for example, in situation where an appliance is suffering from a fault that cannot be rectified through the use of remote commands, such as power failure, for example in a freezer. It will be appreciated that in such situations a notification of the occurrence of the fault is of importance. Such notification is facilitated by the smart home server 101. The appliance may transmit a message with an appropriate alert to the Femto-Cell base station and the smart home server 101 of the Femto-Cell base station may then re-route the message to the user equipment of any user currently within the area covered by the Femto-Cell, so that the fault may be attended to expediently. An alarm signal from a fire or smoke detector may equally be directed to all user equipment currently located in the coverage area of the Femto-Cell to ensure the personal safety of the carriers of the user equipment. To provide this functionality the smart home server 101 is capable to identify the type of the message received. The message may, for example, comprise an indication of its urgency or an indication that the message is to be sent to all users in the vicinity. Alternatively, the message may be sent to the Femto-Cell base station without a destination address. The smart home server 101 may take this as an indication that the message is to be transmitted as a multi-cast message to all of the pieces of user equipment that are currently within the coverage area of the Femto-Cell base station.

The smart home server 101 may optionally as comprise a billing unit arranged to log the number of “home oriented” messages, that is messages sent from a source within the area covered by the Femto-Cell to a recipient that is also within the Femto-Cell without any data transmission on the backhaul connection. Such logging information may be transmitted to an operator of the Femto-Cell base station, for example for billing purposes.

The smart home server 101 is further arranged to identify messages that do not specify a particular destination address or particular destination addresses, such as messages from home appliances, and provide such messages with an appropriate destination address. A message from a fire alarm sensor may, for example, be directed to user equipment of each user currently within the area covered by the Femto-Cell base station. Other messages may relate to or originate from objects specific to a particular user such as a transmitter or transceiver associated with and connected to a wallet or keys of a user and the smart home server 101 is arranged to direct these messages to the user associated with that object.

The Femto-Cell base station shown in FIG. 1 further includes a local message switching centre LMSC 107. The local message switching centre 107 comprises a routing table that dynamically lists user equipment and appliances currently within the coverage area of the Femto-Cell base station. The local message switching centre indexes user equipment and appliances using their phone number (MSISDN).

Also provided in the Femto-Cell base station shown in FIG. 1 is a means 106 for identifying the destination address of a particular message, referred to in FIG. 1 as a Destination Address Sniffer Process (DASP). The SMS message format conforming to the above referred to and incorporated standard is fixed and includes a destination address field which identifies the MSISDN/phone-number that the text message is bound for. The SMS message format can be parsed and the destination address of an SMS message can be extracted and/or viewed.

The operation of the DASP module 106 depends on the nature of the message received by the Femto-Cell base station. If the message is received from a ‘smart’ home appliance the smart home server 101 will have imbued the message with a destination address, as discussed above. In this case the DASP simply refers the destination addresses to the local message switching centre 107 to determine whether or not the destination device is within the area covered by the Femto-Cell base station. If the message in contrast is a mobile originating SMS (SMS-MO) received from within the area covered by the Femto-Cell base station, the DASP extracts the destination address from the SMS mobile originated message format and presents this to the local message switching centre to determine if the destination device is currently within the area covered by the Femto-Cell base station.

The Femto-Cell base station moreover comprises a rerouting unit 105. The rerouting unit 105 causes a re-transmission of messages received from user equipment or appliances located within the area covered by the Femto-Cell base station to destination devices within the area covered by the Femto-Cell base station if the local message switching centre 107 or the DASP 106 indicates that the destination appliance or user equipment is currently located in this area. If the input information received from the local message switching centre 107 and/or the DASP 106 indicates that the destination user equipment or appliance is not within the area of the Femto-Cell base station then the rerouting unit 105 routes the message along the broadband backhaul to the network operator's infrastructure servers.

The Femto-Cell base station may further be arranged to determine the position of a particular device/object/appliance, such as a user's wallet or keys, so that the presence or absence of such an object within the area covered by the Femto-Cell base station can be established. This may be accomplished using RFID technology or similar technologies, which have been omitted from FIG. 1 to improve clarity.

The person skilled in the art will appreciate from FIG. 1 that the only modifications that need to be made to known telecommunications systems to enable the above described re-routing function is to provide the localised message switching centre 107, the destination address sniffer process 106, the re-routing function 105, and optionally the addition of the smart home server 101. No further changes need to be made to the Femto-Cell base station, to appliances or user equipment supported by the Femto-Cell base station or to the network to which the Femto-Cell base station is connected.

It will be appreciated that in the arrangement shown in FIG. 1 the entity making a decision on whether or not the re-routing function should be enabled is embedded within the function of the DASP 106 and the localised message switching centre 107. It will, however, be appreciated that a separate decision making module relying on the input from the DASP 106 and/or the localised message switching centre 107 could alternatively be provided.

FIG. 2 illustrate the message flow associated with re-directing an alert originating from an appliance within the area covered by the Femto-Cell base station to an appliance or user equipment that is also within the area covered by the Femto-Cell. The message originates at the appliance and is wirelessly transmitted in step 201 to transceivers 102 or 104 of the Femto-Cell base station, from where it is forwarded to the smart home server 101. The smart home server 101 in turn forwards the message to the DASP 106, which in step 202 extracts the destination address of the message by parsing the message. In step 203 the extracted destination address is then provided to the local message switching centre 107, which determines, based on a list of destination addresses associated with devices that are currently within the area covered by the Femto-Cell base station, if a device having an address corresponding to the destination address is located within the area covered by the Femto-Cell. The result of this address check is reported back to the DASP in step 204. If the local message switching centre 107 determines that a device having an address corresponding to the destination address is present within the area covered by the Femto-Cell, then the re-routing function of the Femto-Cell base station is activated in step 205. This activation causes the received message to be routed from the smart home server 101 to the local Femto-Cell base station cellular communications stack in step 206. If the message has been recognised by the smart home server 101 as being for multiple recipients, then the DASP 106 will provide plural destination addresses. Steps 203 and 204 are performed for each destination address in this case and plural messages are sent to the Femto-Cell base station cellular communications stack, as indicated by the presence of message paths 206 and 207.

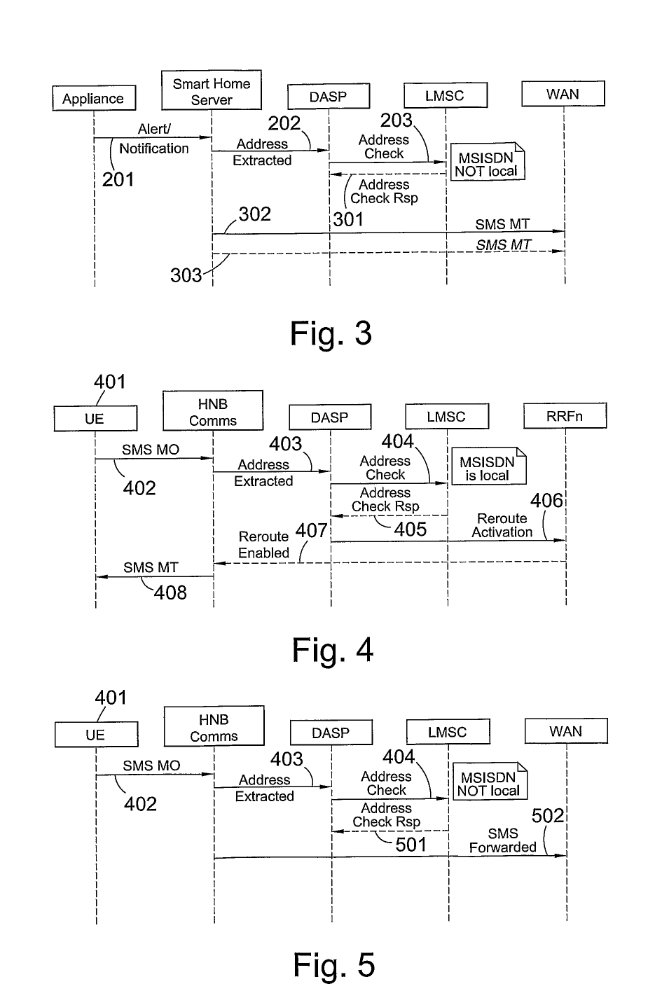

A message from an appliance or user equipment located within the area covered by the Femto-Cell base station may of course also be destined for user equipment that is not within the area covered by the Femto-Cell base station. The message flow associated with this scenario is illustrated in FIG. 3. As can be seen from FIG. 3, the message flow of steps 201 to 203 is the same as that in FIG. 2. For this reason like reference numerals have been used for like parts of the process. The local message switching centre then, however, determines that the intended recipient of the message is not recorded/listed as being within the area covered by the Femto-Cell. This may be because the equipment having the destination address is simply not within range or because the equipment having the destination address is one that is not normally within the area covered by the Femto-Cell. The local message switching centre 107 consequently sends a message indicating that the intended recipient is not local to the DASP 106 in step 301. The local re-routing function is thus not enabled and the smart home server 101 therefore forwards the received message to the macro cell/WAN/backhaul for transmission to the recipient, as indicated by message path 206. If the message is of a nature that requires transmission to multiple recipients, such as a message reporting the activation of a burglar alarm, then the smart home server 101 causes the transmission of the message to such plural receivers as indicated in FIG. 3 by the presence of two message paths 302 and 303.

Localised re-routing, as has been discussed with regard to FIG. 2, is of course not limited to appliance originating messages. The localised re-routing technique of the present invention also applies to mobile originating messages, that is messages originating from user equipment, wherein the message may be user generated, rather than an automatically or appliance generated message. The message flow occurring during the re-routing of such messages is shown in FIG. 4. The message originates in a mobile device/user equipment 401 and is delivered in 402 to the communication interfaces 102 and 104 of the Femto-Cell base station. The message then proceeds to the DASP 106 in step 403. DASP 106 parses the message and extracts the destination address from it. DASP 106 provides the destination address to the local message switching centre 107 in step 404. There it is determined whether or not the equipment associated with the destination address is located within the area covered by the Femto-Cell. In the example shown in FIG. 4 the equipment associated with the destination address is found by the local message switching centre 107 to be within the area covered by the Femto-Cell and a notification to this effect is returned to the DASP 106 in step 405. In response to the receipt of this notification the DASP 106 sends an enable message to the rerouting unit 105 in step 406, which in turn activates the communication ports 102 and/or 104 in step 407 to enable re-transmission of the received message to the local recipient equipment. The communication ports 102 and/or 104 then re-transmit the message to the destination equipment, which may be an appliance or portable user equipment, in step 408. It will be appreciated that in this scenario there is no need for the PLMN core of the Femto-Cell base station, that is the core responsible for transmission of messages to the WAN/backhaul/macrocell/ public land mobile network, to be activated. It will be appreciated that, by locally re-routing messages in this manner backhaul traffic can be reduced. This in particularly advantageous where the messages are message for the control of appliances.

FIG. 5 illustrates a scenario where the message is mobile originating, as in the scenario illustrated in FIG. 4, but where the destination address of the message relate to a device or user equipment that is not currently within the area covered by the Femto-Cell. It will be appreciated that the steps of receiving the message, extracting the destination address in the DASP 106 and forwarding the destination address for messages destined for devices located outside of the area covered by the Femto-Cell are the same as in the scenario illustrated in FIG. 4, as it is only the comparison of the destination address with the local message switching centre's record of user equipment and appliances that are currently within the area covered by the Femto-Cell that determines that the device associated with the destination address is not local to the Femto-Cell. For this reason steps 401 to 404 in FIG. 5 have been given the same reference numerals as the corresponding steps in FIG. 4. Once the local message switching centre 107 has, however, determined that no record of the destination address exists in the list of currently local devices, that is once the local message switching centre 107 has determined that the user equipment associated with the destination address is not within the area covered by the Femto-Cell, and once the DASP 106 has been notified accordingly in step 501, the Femto-Cell base station activates the PLMN core to forward the message to the WANImacrocell/backhaul in step 502, as would be the case in known HNBs.

In a further arrangement in accordance with the present invention a message transmitted the Femto-Cell base station is either deliberately directed towards a destination address that does not exist, towards an address that identifies the Femto-Cell base station as recipient or to another predetermined address. In this arrangement the message is not understood to be intended for the Femto-Cell base station itself but is instead interpreted by the localised message switching centre 107 as being a message that is directed towards a so far unspecified plurality of recipients. An activation message from a fire alarm received at the Femto-Cell base station is one example of such a message. The DASP module 106 is arranged to extract the ‘invalid’ address, the address identifying the Femto-Cell base station or the other predetermined address from a message of this nature received at the Femto-Cell base station and transmits the extracted information to the localised message switching centre 107. The localised message switching centre in turn provides instructions to re-direct the message to all pieces of user equipment present in the area covered by the Femto-Cell, so that any users that may be endangered by the activation of the fire alarm are adequately warned of a potential danger.

It can also be envisaged that certain message types, while seemingly being directed towards the Femto-Cell base station through the use of a destination address identifying the Femto-Cell base station, through the use of another predetermined address or through the use of an invalid destination address, as discussed above, may also be interpreted by the localised message switching centre 107 as being intended for delivery to a predetermined group of users. An activation message received from a burglar alarm, for example, may be directed towards all pieces of user equipment presently within the area covered by the Femto-Cell to warn all users within the area covered by the Femto-Cell of potential danger, much as described above with regard to activation messages received from a fire alarm, but also to predetermined pieces of user equipment, such as to user equipment known to belong to an adult who may be best suited for dealing with the activation of the burglar alarm and its consequences.

It will be appreciated that the above description of the present invention is made by way of example only to illustrate the present invention. The person skilled in the art will appreciate that the present invention is not limited by the examples provided above.

1. A Femto-Cell base station comprising:
a switching means arranged to route a text based message received from a transmitter that is in direct communicative contact with the Femto-Cell base station and destined for a recipient that is also in direct communicative contact with the Femto-Cell base station for direct transmission to the recipient.

2. A Femto-Cell base station according to claim 1, wherein the switching means comprises means for determining a destination address from a message received at the Femto-Cell base station.

3. A Femto-Cell base station according to claim 1, wherein the switching means comprises means arranged to determine whether a destination device specified by a message received at the Femto-Cell base station is located within an area covered by the Femto-Cell base station.

4. A Femto-Cell base station according to claim 3, wherein said means comprises a record of devices that are in direct communicative contact with the Femto-Cell base station.

5. A Femto-Cell base station according to claim 1, further comprising means arranged to determine that a device is in direct communicative contact with the Femto-Cell base station and to add an identifier of the device to a record of devices in direct communicative contact with the Femto-Cell base station.

6. A Femto-Cell base station according to claim 1, further comprising a processor arranged to associate messages received from within an area covered by the Femto-Cell base station with one or more destination addresses according to predetermined rules.

7. A Femto-Cell base station according to claim 6, further comprising input means allowing inputting further rates and/or altering existing ones of the predetermined rules.

8. A Femto-Cell base station comprising:
a processor arranged to determine a message type of a message received at the Femto-Cell base station through direct communication and to forward the message to one or more distribution addresses, the processor arranged to select the destination address based on the message type and on predetermined rules.

9. A Femto-Cell base station comprising:
a Short Messaging Service Message Switching Centre.

10. A Femto-Cell base station comprising:
a rule or rules linking two or more pieces of user equipment and/or appliances that can establish a direct communication contact with the Femto-Cell base station,
means for monitoring the position of the linked pieces of user equipment and/or appliances within the area covered by the Femto-Cell base station,
a processor arranged to determine if the positions of the pieces of user equipment and/or appliances are in accordance with the rule or rules and to send a message to user equipment and/or an appliance if the positions are not within the rules.

11. A Femto-Cell base station arranged for controlling appliances, the Femto-Cell base station arranged to determine from predetermined rules a change of an operating parameter of the appliance, to monitor a condition associated with the change of operating parameter of the appliance, and to send a text based control message for changing the operating parameter to the appliance when the condition is fulfilled.

12. A system comprising a Femto-Cell base station according to claim 1 and one or more appliances arranged to establish communicative contact with the Femto-Cell base station.

13. A method of local message routing within a Femto-Cell, comprising:
receiving at a Femto-Cell base station a text based message having a destination address;
determining whether or not a device associated with the destination address is in direct communicative contact with the Femto-Cell base station; and
if it is determined that the device is in direct communicative contact with the Femto-Cell base station, transmitting the message directly to the device.

14. A method according to claim 13, further comprising determining a destination address from the received message.

15. A method according to claim 13, further comprising maintaining a record of devices in direct communicative contact with the Femto-Cell base station and basing said determination on said record.

16. A method according to claim 13, further comprising determining that a device is in direct communicative contact with the Femto-Cell base station and adding an identifier of the device to a record of devices that is in direct communicative contact with the Femto-Cell base station.

17. A method according to claim 13, further comprising identifying a type of a message received at the Femto-Cell base station and associating a predetermined type of message with a destination address or destination addresses according to predetermined rules.

18. A method of routing a message in a Femto-Cell base station comprising:
receiving the message via a direct communication link, identifying a message type of the received message,
selecting one or more destination addresses based on the identified message type and on predetermined rules, and
forwarding the message to the selected destination addresses.

19. A method according to claim 13, further comprising determining a location of a device that is in direct communication contact with the Femto-Cell base station within an area covered by the Femto-Cell base station.

20. A method according to claim 19, further comprising determining a change in the location of the device and sending a message to the device or to a further device based on the determination.

21. A method according to claim 20, further comprising determining, prior to the sending of the said message, whether a condition for the sending of the message is fulfilled.

22. A method of creating alert messages in a Femto-Cell base station comprising:
using a rule or rules to link two or more pieces of user equipment and/or appliances that can establish a direct communication link with the Femto-Cell base station,
monitoring the position of the linked pieces of user equipment and/or appliances within the area covered by the Femto-Cell base station,
determining if the positions of the pieces of user equipment and/or appliances are in accordance with the rule or rules and
sending a message to user equipment and/or an appliance if the positions are not within the rules.

23. A method of controlling appliances with a Femto-Cell base station comprising:
determining from pre-determined rules a change for an operating parameter of an appliance,
monitoring a condition associated with the change of the operating parameter of the appliance, and
sending a text based control message for changing the operating parameter to the appliance when the condition is fulfilled.

24. A method of controlling appliances with a Femto-Cell base station comprising:
obtaining an indication of a need for a change in an operating parameter of an appliance,
monitoring a condition associated with the change in the operating parameter of the appliance, and
sending a message from a Femto-Cell base station to the appliance for changing the operating parameter of the appliance if the condition is fulfilled.

25. A computer program code arranged to cause a Femto-Cell base station to perform the method according to claim 13 when executed in the Femto-Cell base station.

26. A data carrier comprising a computer program code according to claim 25.
